(19) United States
(12) Patent Application Publication
(10) Pub. No.: US 2026/0183174 A1
(43) Pub. Date: Jul. 2, 2026

(54) SELF-BRAKING WALKER APPARATUS

(71) Applicant: Jacqueline Morgan, Garden Grove, CA (US)

(72) Inventor: Jacqueline Morgan, Garden Grove, CA (US)

(21) Appl. No.: 19/001,969

(22) Filed: Dec. 26, 2024

(51) Int. Cl. A61H 3/04

(52) U.S. Cl. CPC A61H 3/04; A61H 2003/046

(57) ABSTRACT

A walker apparatus for supporting a user while standing or walking includes a frame and a wheel rotatably mounted to a bottom of the frame. A brake mechanism is coupled to the frame which is engageable with the wheel to resist rotation of the wheel. The brake mechanism is biased to engage the wheel. A brake de-actuator is mounted to the frame and is operatively coupled to the brake mechanism. Operating the brake de-actuator disengages the brake mechanism from the wheel, permitting the wheel to rotate.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to walkers and more particularly pertains to a new walker for supporting a user while standing or walking.

### (2) Description of Related Art including information disclosed under 37 CFR 1.97 and 1.98.

The prior art relates to myriad walkers with various types of braking mechanisms. Typically, the braking mechanisms used in walkers are biased to unlock or have no bias to allow the user to roll the walker across the floor unless the braking mechanism is engaged. However, the prior art fails to disclose such a walker apparatus with a braking mechanism that biases to lock and must be operated to allow the wheels of the walker to rotate.

### (h) Brief Summary of the Invention

An embodiment of the disclosure meets the needs presented above by generally comprising a frame and a wheel rotatably mounted to a bottom of the frame. A brake mechanism is coupled to the frame which is engageable with the wheel to resist rotation of the wheel. The brake mechanism is biased to engage the wheel. A brake de-actuator is mounted to the frame and is operatively coupled to the brake mechanism. Operating the brake de-actuator disengages the brake mechanism from the wheel, permitting the wheel to rotate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a first side view of a walker apparatus according to an embodiment of the disclosure.

FIG. 2 is a second side view of an embodiment of the disclosure.

FIG. 3 is a front view of an embodiment of the disclosure.

FIG. 4 is a rear view of an embodiment of the disclosure.

FIG. 5 is a top view of an embodiment of the disclosure.

FIG. 6 is a detail view of a brake mechanism an embodiment of the disclosure taken from Window 6 in FIG. 2.

FIG. 7 is a top detail view of a grip and a control arm of a brake mechanism of the disclosure taken from Window 7 in FIG. 1.

FIG. 8 is a bottom detail view of a grip and a control arm of a brake mechanism of the disclosure taken from Window 7 in FIG. 1.

### (j) DETAILED DESCRIPTION OF THE INVENTION

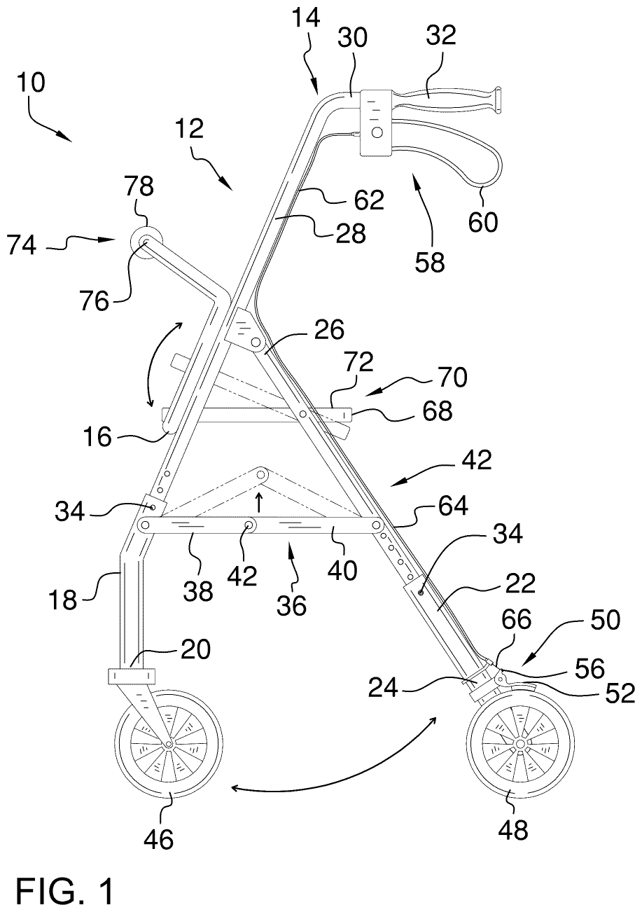

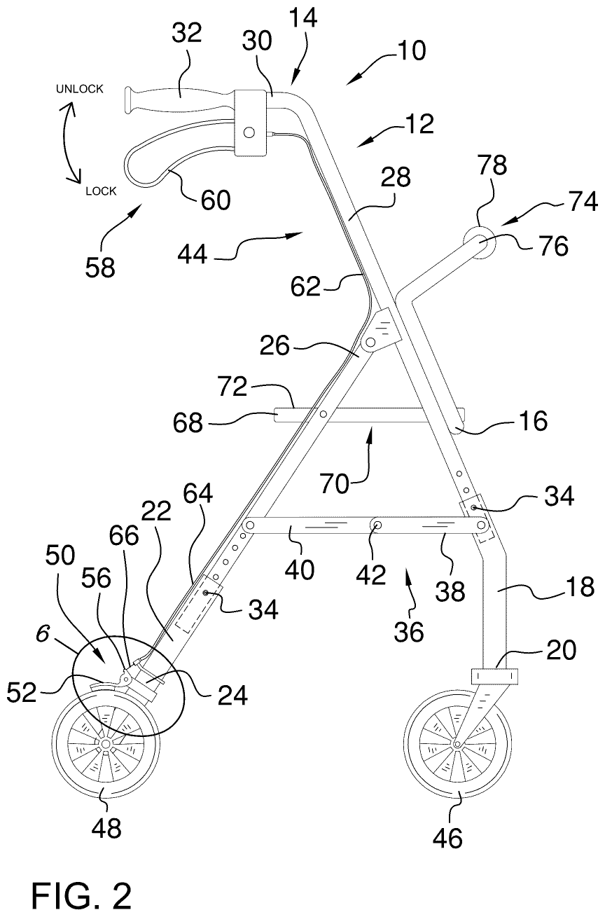

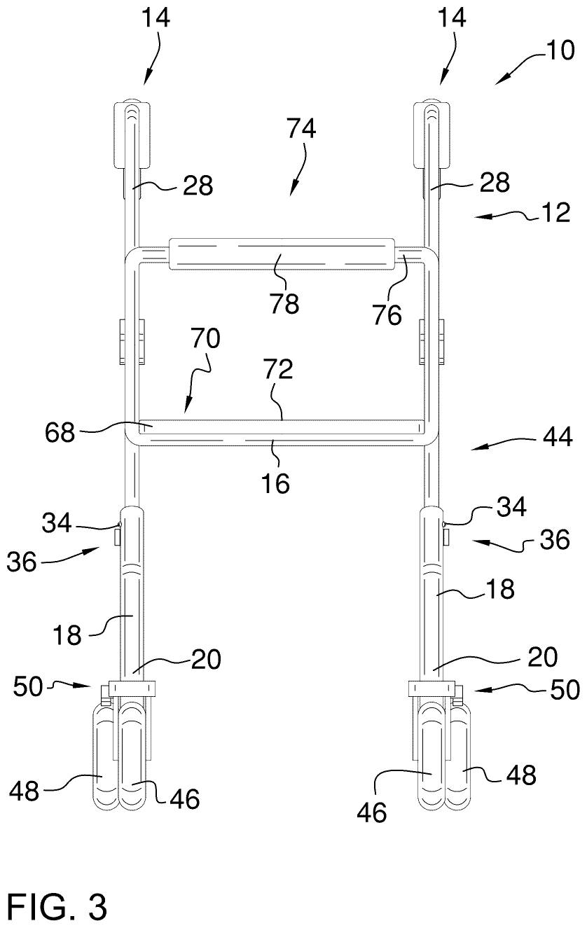

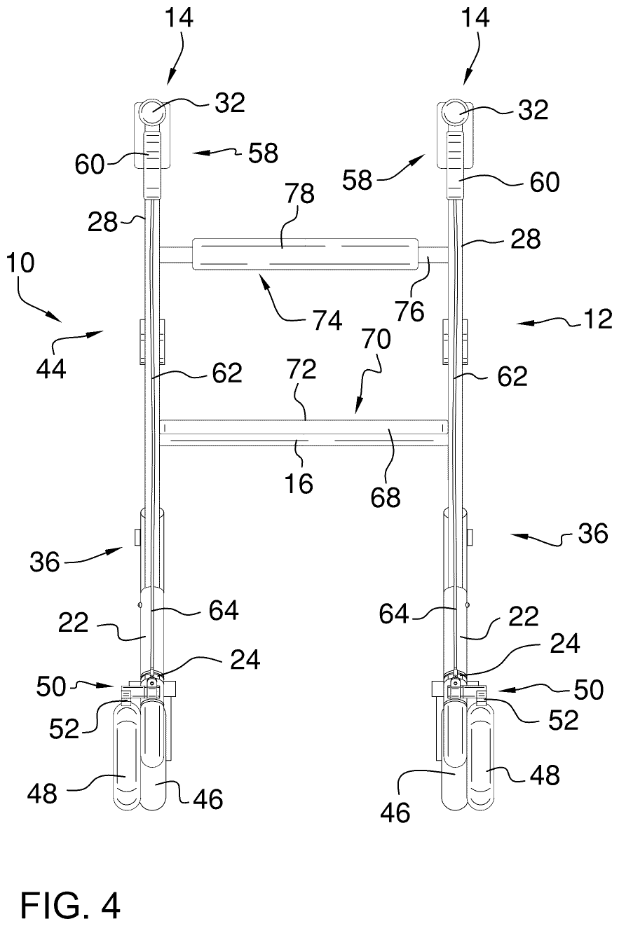

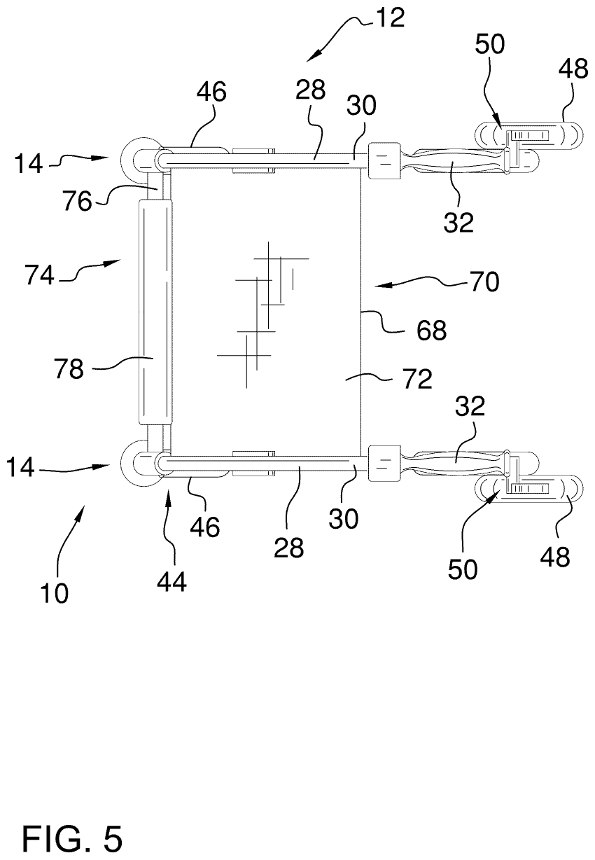

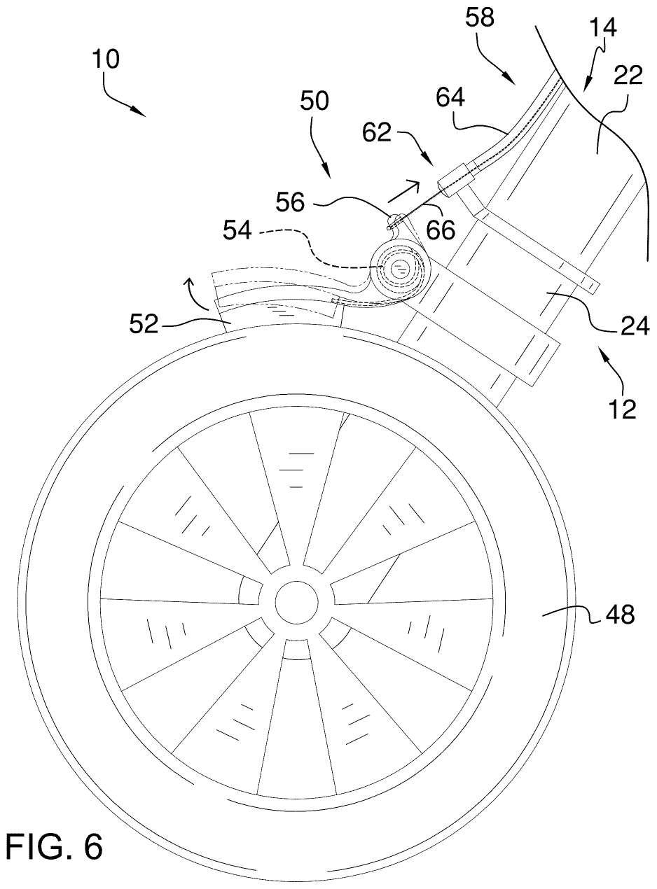

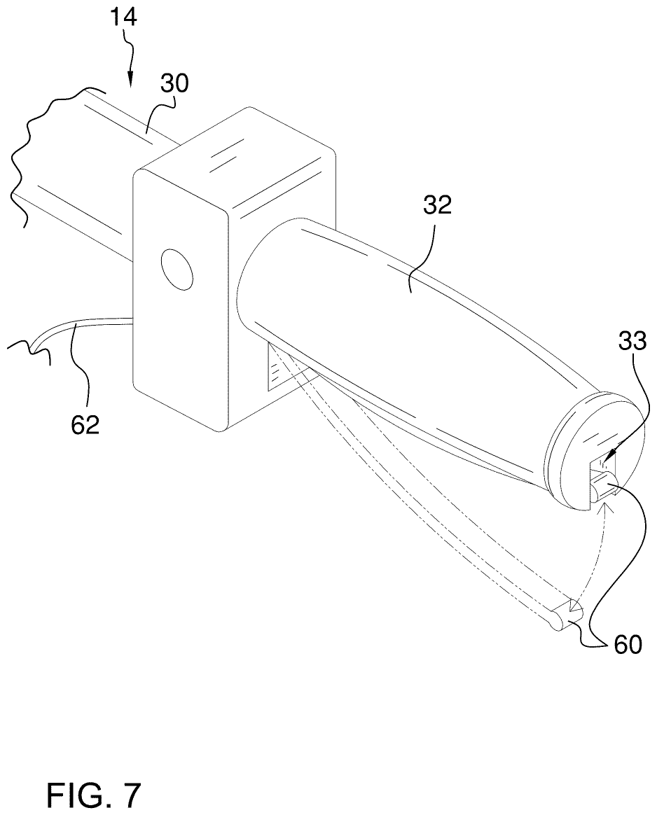

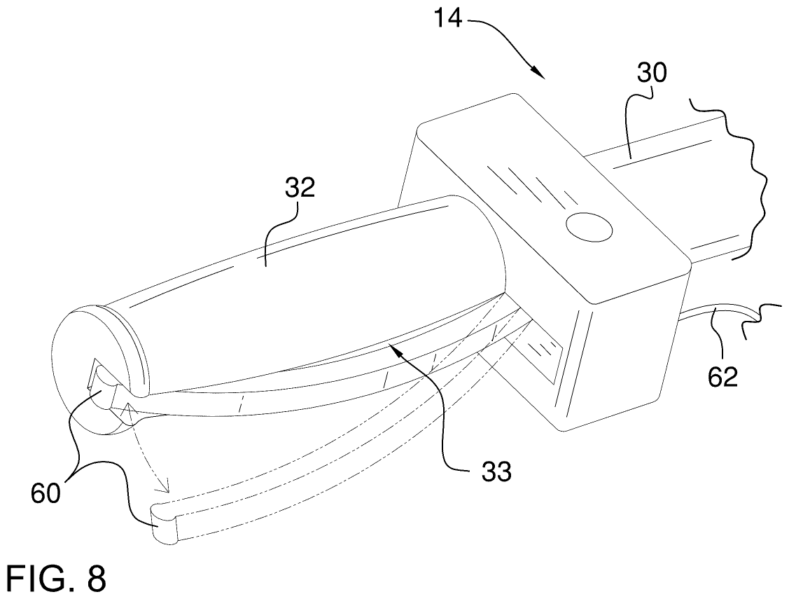

With reference now to the drawings, and in particular to FIGS. 1 through 8 thereof, a new walker embodying the principles and concepts of an embodiment of the disclosure and generally designated by the reference numeral 10 will be described.

As best illustrated in FIGS. 1 through 8, the walker apparatus 10 generally comprises a frame 12 which includes a pair of lateral assemblies 14 coupled together by a crossbar 16. Each lateral assembly 14 comprises a front leg 18, a rear leg 22, and a handle 28. A top end 26 of the rear leg 22 is pivotably coupled to the front leg 18 such that a bottom end 24 of the rear leg 22 is movable alternately toward and away from a lower end 20 of the front leg 18. The handle 28 is coupled to the front leg 18 adjacent to the top end 26 of the rear leg 22 and extends away from the front leg 18 and the rear leg 22. The frame 12 is positionable in a use configuration in which the rear legs 22 of both lateral assemblies 14 extend downwardly and rearwardly from their respective front legs 18 with respect to the frame 12. The rear legs 22 may be moved from their positions in the use configuration of the frame 12 toward the front legs 18 to collapse the frame 12, facilitating compact storage of the walker apparatus 10. While the frame 12 is in the use configuration, the handle 28 of each lateral assembly 14 extends upwardly and rearwardly from the front leg 18 with respect to the frame 12. Each lateral assembly 14 includes a grip 32 coupled to a distal end 30 of the handle 28 of the lateral assembly 14 with respect to the front leg 18. The front and rear legs 18, 22 of the lateral assemblies 14 are adjustable in length via multiple segments which are slidable with respect to each other and securable in place via biased pins 34 which extend through holes in each segment. The crossbar 16 is coupled to and extends between the front legs 18 of the lateral assemblies 14.

Each lateral assembly 14 further comprises a linkage 36 which couples the front leg 18 to the rear leg 22 and acts to secure the frame 12 in the use configuration. The linkage 36 comprises a front link 38 and a rear link 40. The front link 38 is pivotably coupled to the front leg 18, and the rear link 40 is pivotably coupled to the rear leg 22. The front link 38 and the rear link 40 are pivotably coupled to each other at a medial pivot 42 positioned between the front leg 18 and the rear leg 22. The front and rear links 38, 40 are aligned colinearly when the frame 12 is in the use configuration, preventing the front and rear legs 18, 22 of the respective lateral assembly 14 from spreading farther apart and binding against each other when the front and rear legs 18, 22 are pushed toward each other. The medial pivot 42 may be moved upwardly to bring the front and rear links 38, 40 out of alignment with each other and draw the front and rear legs 18, 22 toward each other, thereby collapsing the frame 12 for compact storage.

A pair of front wheels 46 and a pair of rear wheels 48 are rotatably mounted to the frame 12. Each front wheel 46 is positioned on the lower end 20 of the front leg 18 of a respective lateral assembly 14, and each rear wheel 48 is positioned on the bottom end 24 of the rear leg 22 of a respective lateral assembly 14 of the pair of lateral assemblies 14.

A pair of brake mechanisms 50 is coupled to the frame 12. Each brake mechanism 50 is engageable with a respective rear wheel 48 of the pair of rear wheels 48 to resist rotation of the respective rear wheel 48. Each brake mechanism 50 of the pair of brake mechanisms 50 comprises a brake arm 52, a bias member 54, and a lever 56. The brake arm 52 is pivotably coupled to the frame 12 and is movable alternately toward and away from the respective rear wheel 48. The brake arm 52 is positionable in an engaged state in which the brake arm 52 abuts an outer surface of the respective rear wheel 48. The bias member 54 is coupled to the brake arm 52 and is arrange to urge the brake arm 52 toward the respective rear wheel 48. The bias member 54 comprises a torsion spring but may comprise another type of spring, an elastic band, or the like. The lever 56 is coupled to the brake arm 52 opposite a pivot point with the frame 12 and is movable to pivot the brake arm 52 away from the respective rear wheel 48.

A pair of brake de-actuators 58 is mounted to the frame 12, and each brake de-actuator 58 is operatively coupled to a respective brake mechanism 50 of the pair of brake mechanisms 50. Each brake de-actuator 58 comprises a control arm 60 pivotably mounted to the frame 12 and a Bowden cable 62 which couples the control arm 60 to the respective braking mechanism. The Bowden cable 62 includes an inner cable 66 which is slidably housed within a sheath 64. The sheath 64 is attached to the frame 12 and extends between the control arm 60 and respective brake mechanism 50. The inner cable 66 is attached to the control arm 60 and to the lever 56 of the respective brake mechanism 50. The control arm 60 is mounted adjacent to the grip 32 of a respective one of the lateral assemblies 14. The control arm 60 is pivotable toward the grip 32 to pull the inner cable 66 of the Bowden cable 62 through the sheath 64 and pull the lever 56 of the respective brake mechanism 50, thereby disengaging the brake arm 52 of the respective brake mechanism 50 from the respective rear wheel 48. The grip 32 of each lateral assembly 14 defines a groove 32 which accommodates the control arm 60 of the respective brake de-actuator 58 when the control arm 60 is pivoted toward the grip 32. The groove 32 of the grip 32 of each lateral assembly 14 facilitates wrapping a hand completely around the grip 32 when the control arm 60 is actuated instead of requiring the hand to reach downwardly toward the control arm 60.

A seat 68 is coupled to the frame 12 and is positioned between the pair of lateral assemblies 14. The seat 68 is pivotably coupled to the rear leg 22 of each lateral assembly 14. The seat 68 is positionable in a support position 70 when the frame 12 is in the use configuration 44 wherein the seat 68 rests on the crossbar 16 and a support surface 72 of the seat 68 faces upwardly with respect to the frame 12. The seat 68 may be pivoted away from the support position 70 to permit the frame 12 to collapse. A backrest 74 coupled to the frame 12 above the seat 68 relative to the frame 12. The backrest 74 is coupled to and extends between the handles 28 of the pair of lateral assemblies 14. The backrest 74 comprises a bar 76 and a padding 78, wherein the bar 76 extends between the pair of lateral assemblies 14 and the padding 78 surrounding the bar 76. The padding 78 may comprise any suitable material for cushioning such as a plastic foam, down, cotton, or the like.

In use, the walker apparatus 10 may be grasped by the grips 32 while the frame 12 is in the use configuration 44 to stabilize a user while standing and walking. The brake mechanisms 50 are biased to engage the rear wheels 48, thereby securing the walker apparatus 10 in place relative to a floor surface upon which the wheels 46, 48 are placed. In order to disengage the brake mechanisms 50 to allow the rear wheels 48 to rotate, the control arms 60 are pulled toward their respective grips 32. The frame 12 may be placed in the use configuration 44 or collapsed as described above. While in the use configuration 44, the seat 68 may be placed in the support position 70 such that the user may rest on the seat 68 and against the backrest 74.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A walker apparatus comprising:
a frame;
a wheel rotatably mounted to a bottom of the frame;
a brake mechanism coupled to the frame, the brake mechanism being engageable with the wheel to resist rotation of the wheel, the brake mechanism being biased to engage the wheel; and
a brake de-actuator mounted to the frame, the brake de-actuator being operatively coupled to the brake mechanism.

2. The walker apparatus of claim 1, wherein the brake mechanism comprises:
a brake arm pivotably coupled to the frame, the brake arm being movable alternately toward and away from the wheel, the brake arm being positionable in an engaged state in which the brake arm abuts an outer surface of the wheel; and
a bias member coupled to the brake arm, the bias member urging the brake arm toward the wheel.

3. The walker apparatus of claim 2, wherein the bias member comprises a torsion spring.

4. The walker apparatus of claim 2, wherein the brake mechanism further comprises a lever coupled to the brake arm, the lever being movable to pivot the brake arm away from the wheel, the brake de-actuator being operatively coupled to the lever.

5. The walker apparatus of claim 4, wherein the brake de-actuator comprises:
a control arm pivotably mounted to the frame; and
a Bowden cable coupling the control arm to the brake mechanism, the control arm being pivotable with respect to the frame to disengage the brake mechanism from the wheel via pulling an inner cable of the Bowden cable.

6. The walker apparatus of claim 5, wherein:
the frame comprises a grip at a top of the frame; and
the control arm is pivotable alternately toward and away from the grip of a lateral assembly of the pair of lateral assemblies, the control arm being pivotable toward the grip to pull the inner cable of the Bowden cable to disengage the brake mechanism from the wheel.

7. The walker apparatus of claim 1, wherein:
the frame comprises:
a pair of lateral assemblies, the pair of lateral assemblies being coupled to each other, each lateral assembly of the pair of lateral assemblies comprising:
a front leg;
a rear leg coupled to the front leg, a bottom end of the rear leg being spaced rearwardly of the front leg relative to the frame when the frame is positioned in a use configuration;
a handle coupled to the front leg adjacent to the top end of the rear leg, the handle extending upwardly and rearwardly from the front leg with respect to the frame when the frame is in the use configuration; and
a grip coupled to a distal end of the handle with respect to the front leg;
the wheel is one of a plurality of wheels which includes a pair of front wheels and a pair of rear wheels, each front wheel being positioned on the lower end of the front leg of a respective lateral assembly of the pair of lateral assemblies, each rear wheel being positioned on the bottom end of the rear leg of a respective lateral assembly of the pair of lateral assemblies; and
the brake mechanism is operatively coupled to an associated wheel of the plurality of wheels.

8. The walker apparatus of claim 7, wherein:
the brake mechanism is one of a pair of brake mechanisms, each brake mechanism of the pair of brake mechanisms being engageable with a respective rear wheel of the pair of rear wheels to resist rotation of the respective rear wheel; and
the brake de-actuator is one of a pair of brake de-actuators, each brake de-actuator of the pair of brake de-actuators being operatively coupled to a respective brake mechanism of the pair of brake mechanisms.

9. The walker apparatus of claim 8, wherein each brake mechanism of the pair of brake mechanisms comprises:
a brake arm pivotably coupled to the frame, the brake arm being movable alternately toward and away from the respective rear wheel, the brake arm being positionable in an engaged state in which the brake arm abuts an outer surface of the respective rear wheel; and
a bias member coupled to the brake arm, the bias member urging the brake arm toward the respective rear wheel.

10. The walker apparatus of claim 9, wherein the bias member of each brake mechanism comprises a torsion spring.

11. The walker apparatus of claim 9, wherein each brake mechanism further comprises a lever coupled to the brake arm, the lever being movable to pivot the brake arm away from the respective rear wheel.

12. The walker apparatus of claim 11, wherein each brake de-actuator comprises:
a control arm pivotably mounted to the frame, the control arm being pivotable alternately toward and away from the grip of a respective lateral assembly of the pair of lateral assemblies; and
a Bowden cable coupling the control arm to the respective brake mechanism, the control arm being pivotable toward the grip of the respective lateral assembly to disengage the respective brake mechanism from the respective rear wheel via pulling an inner cable of the Bowden cable.

13. The walker apparatus of claim 7, wherein, for each lateral assembly of the pair of lateral assemblies, a top end of the rear leg is pivotably coupled to the front leg, a bottom end of the rear leg being movable alternately toward and away from the lower end of the front leg, the frame being positionable in the use configuration in which the rear leg extends downwardly and rearwardly from the front leg with respect to the frame.

14. The walker apparatus of claim 13, wherein each lateral assembly of the pair of lateral assemblies further comprises a linkage coupling the front leg to the rear leg, the linkage comprising a front link and a rear link, the front link being pivotably coupled to the front leg, the rear link being pivotably coupled to the rear leg, the front link and the rear link being pivotably coupled to each other at a medial pivot, the front and rear links being aligned colinearly when the frame is in the use configuration, the frame being collapsible from the use configuration by moving the medial pivot upwardly with respect to the frame to urge the front leg and the rear leg toward each other.

15. The walker apparatus of claim 7, wherein the front leg of each lateral assembly and the rear leg of each lateral assembly are adjustable in length.

16. The walker apparatus of claim 7, wherein the frame further comprises a crossbar coupling the pair of lateral assemblies to each other, the crossbar being coupled to the front leg of each lateral assembly of the pair of lateral assemblies, further comprising a seat coupled to the frame, the seat being coupled to and positioned between the pair of lateral assemblies, the seat being pivotably coupled to the rear leg of each lateral assembly of the pair of lateral assemblies, the seat being positionable in a support position when the frame is in the use configuration, the support position including the seat resting on the crossbar such that a support surface of the seat faces upwardly with respect to the frame.

17. The walker apparatus of claim 16, further comprising a backrest coupled to the frame, the backrest being coupled to and extending between the handles of the pair of lateral assemblies, the backrest being spaced upwardly from the seat with respect to the frame when the seat is in the support position, the backrest comprising a bar and a padding, the bar extending between the pair of lateral assemblies, the padding surrounding the bar.

18. A walker apparatus comprising:
a frame, the frame comprising:
a pair of lateral assemblies, each lateral assembly of the pair of lateral assemblies comprising:
a front leg, the front leg being adjustable in length;
a rear leg coupled to the front leg, a top end of the rear leg being pivotably coupled to the front leg, a bottom end of the rear leg being movable alternately toward and away from the lower end of the front leg, the frame being positionable in a use configuration in which the rear leg extends downwardly and rearwardly from the front leg with respect to the frame, the rear leg being adjustable in length;
a handle coupled to the front leg adjacent to the top end of the rear leg, the handle extending upwardly and rearwardly from the front leg with respect to the frame when the frame is in the use configuration;
a grip coupled to a distal end of the handle with respect to the front leg; and
a linkage coupling the front leg to the rear leg, the linkage comprising a front link and a rear link, the front link being pivotably coupled to the front leg, the rear link being pivotably coupled to the rear leg, the front link and the rear link being pivotably coupled to each other at a medial pivot, the front and rear links being aligned colinearly when the frame is in the use configuration, the frame being collapsible from the use configuration by moving the medial pivot upwardly with respect to the frame to urge the front leg and the rear leg toward each other; and
a crossbar coupling the pair of lateral assemblies to each other, the crossbar being coupled to the front leg of each lateral assembly of the pair of lateral assemblies;
a pair of front wheels rotatably mounted to the frame, each front wheel being positioned on the lower end of the front leg of a respective lateral assembly of the pair of lateral assemblies;
a pair of rear wheels rotatably mounted to the frame, each rear wheel being positioned on the bottom end of the rear leg of a respective lateral assembly of the pair of lateral assemblies;
a pair of brake mechanisms coupled to the frame, each brake mechanism of the pair of brake mechanisms being engageable with a respective rear wheel of the pair of rear wheels to resist rotation of the respective rear wheel, each brake mechanism of the pair of brake mechanisms comprising:
a brake arm pivotably coupled to the frame, the brake arm being movable alternately toward and away from the respective rear wheel, the brake arm being positionable in an engaged state in which the brake arm abuts an outer surface of the respective rear wheel;
a bias member coupled to the brake arm, the bias member urging the brake arm toward the respective rear wheel, the bias member comprising a torsion spring; and
a lever coupled to the brake arm, the lever being movable to pivot the brake arm away from the respective rear wheel;
a pair of brake de-actuators mounted to the frame, each brake de-actuator of the pair of brake de-actuators being operatively coupled to a respective brake mechanism of the pair of brake mechanisms, each brake de-actuator comprising:
a control arm pivotably mounted to the frame, the control arm being pivotable alternately toward and away from the grip of a respective lateral assembly of the pair of lateral assemblies; and
a Bowden cable coupling the control arm to the respective brake mechanism, the control arm being pivotable toward the grip of the respective lateral assembly to disengage the respective brake mechanism from the respective rear wheel via pulling an inner cable of the Bowden cable;
a seat coupled to the frame, the seat being coupled to and positioned between the pair of lateral assemblies, the seat being pivotably coupled to the rear leg of each lateral assembly of the pair of lateral assemblies, the seat being positionable in a support position when the frame is in the use configuration, the support position including the seat resting on the crossbar such that a support surface of the seat faces upwardly with respect to the frame; and
a backrest coupled to the frame, the backrest being coupled to and extending between the handles of the pair of lateral assemblies, the backrest being spaced upwardly from the seat with respect to the frame when the seat is in the support position, the backrest comprising a bar and a padding, the bar extending between the pair of lateral assemblies, the padding surrounding the bar.
